(19) United States
(12) Patent Application Publication
(10) Pub. No.: US 2012/0279335 A1
(43) Pub. Date: Nov. 8, 2012

(54) ACTUATOR

(76) Inventors: Man Fat WONG, Hong Kong (CN); TianGang Zhang, Shenzhen (CN)

(21) Appl. No.: 13/464,486

(22) Filed: May 4, 2012

(30) Foreign Application Priority Data
May 6, 2011 (CN) 201110117477.4
Aug. 11, 2011 (CN) 201110230210.6

(51) Int. Cl. F16H 35/10; H02K 7/116

(52) U.S. Cl. 74/405; 74/421 A

(57) ABSTRACT

An actuator, especially for use in a game machine, includes a motor driving an output via a gear train. The motor is mounted to a support plate. The gear train includes a number of dual cogs rotatably mounted on fixed shafts. At least one of the fixed shafts is fixed to the support plate by way of a spacer. The support plate has a mounting hole formed in the support plate with an axially extending hollow boss and the spacer is fixed to the support plate by being press fitted into the mounting hole and boss. One of the fixed shafts is fixed to the support plate by a shaft seat which is fixed to the support plate by a snap-fit connection.

### CROSS REFERENCE TO RELATED APPLICATIONS

This non-provisional patent application claims priorities under 35 U.S.C. §119(a) from Patent Application No. 201110117477.4 filed in The People's Republic of China on May 6, 2011, and Patent Application No. 201110230210.6 filed in The People's Republic of China on Aug. 11, 2011.

### FIELD OF THE INVENTION

This invention relates to an actuator and in particular, to an actuator for use in a game machine.

### BACKGROUND OF THE INVENTION

A traditional actuator used in a game machine comprises a gearbox. The gearbox comprises a housing, a support plate mounted to the housing, a fixed shaft fixed to the support plate and a gear rotatably mounted to the fixed shaft. The fixed shaft passes through an aperture in the support plate. A rivet hole is preformed in the end of the fixed shaft. After the shaft has been positioned in the aperture the rivet hole is deformed by a riveting process to securely fasten the fixed shaft to the support plate. The cost is high due to the rivet hole and the riveting process.

In another traditional actuator, a threaded hole is formed in the support plate. A shaft seat having an outer thread is firmly mounted to the threaded hole to support the fixed shaft. The cost is also high due to the threaded hole and the threaded shaft seat.

Therefore, there is a desire to reduce the cost of the gearbox and/or the actuator.

### SUMMARY OF THE INVENTION

Accordingly, in one aspect thereof, the present invention provides an actuator comprising a support plate, a motor mounted to the support plate and driving an output shaft via a gear train, wherein the gear train comprises a number of dual gears rotatably mounted on respective fixed shafts mounted to the support plate and extending substantially perpendicular to the support plate.

Preferably, a spacer is fixed to a mounting hole formed in the support plate, the spacer having a hole defined therein and one of the fixed shafts being fixed to the spacer as a press fit in the hole of the spacer.

Preferably, the outer diameter of said fixed shaft is from 1.0 to 2.0 mm.

Preferably, the outer diameter of the spacer is from 2.0 to 4.0 mm.

Preferably, the thickness of the support plate is from 0.8 to 2.0 mm.

Preferably, a hollow axial boss is formed around the mounting hole, and the spacer is a press fit in the mounting hole and the boss.

Preferably, the thickness of the support plate, including the axial height of the boss is from 1.5 to 2.5 mm.

Preferably, the gear train further comprises a plastic bushing rotatably disposed on one of the fixed shafts, and one of the dual gears is rotatably mounted to the bushing.

Preferably, the dual gear mounted to the bushing comprises a driven gear and a pinion that is axially separable from the driven gear, both the driven gear and the pinion having axially extending teeth arranged to be mutually engaged to make the driven gear and the pinion rotate together, and a compression spring being mounted to the bushing to urge the teeth into engagement, the teeth being adapted to cause an axial separation between the driven gear and the pinion, against the urging of the spring, when torque between the driven gear and the pinion exceeds a predetermined value, whereby the driven gear can rotate with respect to the pinion.

Preferably, a flange is formed at one end of the bushing to support the spring or the dual gear.

Preferably, a shaft seat is disposed in a shaft hole defined in the support plate to support one of the fixed shafts, the shaft seat being fixed to the support plate by a snap-fit connection.

Preferably, at least two detent holes are formed in the support plate, and a mounting plate having integral lugs is integrally formed with the shaft seat, hooks being formed on the lugs to snap-fit and interlock with respective detent holes.

Preferably, at least one washer is mounted to the fixed shaft supported by the shaft seat through the shaft hole before the shaft seat is fixed to the support plate to adjust end play of the dual gear mounted to the fixed shaft.

Preferably, a first washer and a second washer are mounted to one of the fixed shafts and axially stacked between the support plate and the dual gear mounted on said fixed shaft to space the dual gear from the support plate by a desired distance.

Preferably, the first washer is disposed between the second washer and the dual gear, and the outer diameter of the first washer is larger than the outer diameter of the second washer.

Preferably, the first washer and the second washer are made of stainless steel.

Preferably, at least one third washer is disposed between the second washer and the support part to adjust the position of the dual gear with respect to the support plate.

According to a second aspect thereof, the present invention also provides a game machine incorporating an actuator as described above, wherein the output shaft drives a driven member of the game machine.

Preferably, the driven member is a camera that is electrically connected to the game machine.

### BRIEF DESCRIPTION OF THE DRAWINGS

A preferred embodiment of the invention will now be described, by way of example only, with reference to figures of the accompanying drawings. In the figures, identical structures, elements or parts that appear in more than one figure are generally labeled with a same reference numeral in all the figures in which they appear. Dimensions of components and features shown in the figures are generally chosen for convenience and clarity of presentation and are not necessarily shown to scale. The figures are listed below.

FIG. 1 illustrates an actuator according to a first embodiment of the present invention;

FIG. 2 illustrates the interior of the actuator of FIG. 1, including a support plate, motor, fixed shafts, dual gears, and an output shaft;

FIG. 3 and FIG. 4 illustrate the support plate, the motor and the fixed shafts of the actuator;

FIG. 5 illustrates a cross section of the support plate, one of the fixed shafts and its spacer;

FIG. 6 illustrates the support plate, the fixed shafts and a plastic bushing on one of the fixed shafts;

FIG. 7 illustrates the plastic bushing and its corresponding dual gear and fixed shaft;

FIG. 8 illustrates the plastic bushing;

FIG. 9 illustrates the support plate, the fixed shafts, a shaft hole and three detent holes formed in the support plate;

FIG. 10 illustrates a plastic shaft seat;

FIG. 11 and FIG. 12 illustrate the support plate, the fixed shafts and stacked washers between the support plate and a fourth dual gear; and

FIG. 13 is a sectional view of the support plate and two of the fixed shafts.

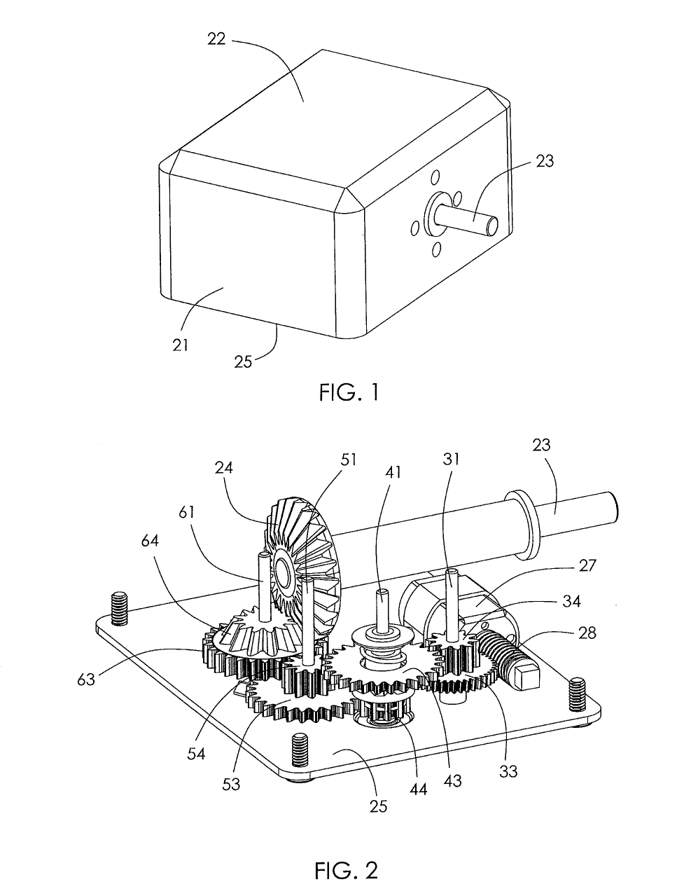

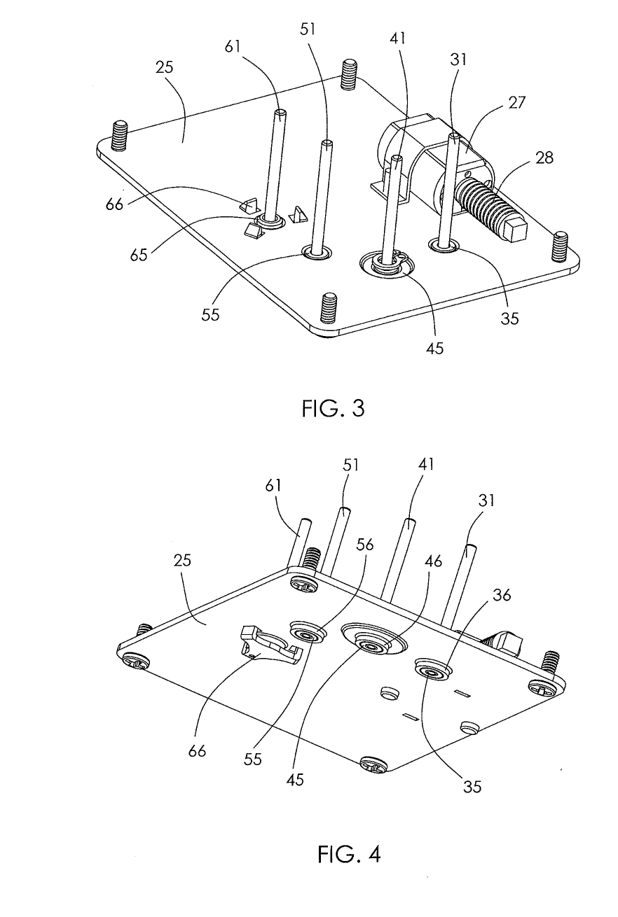

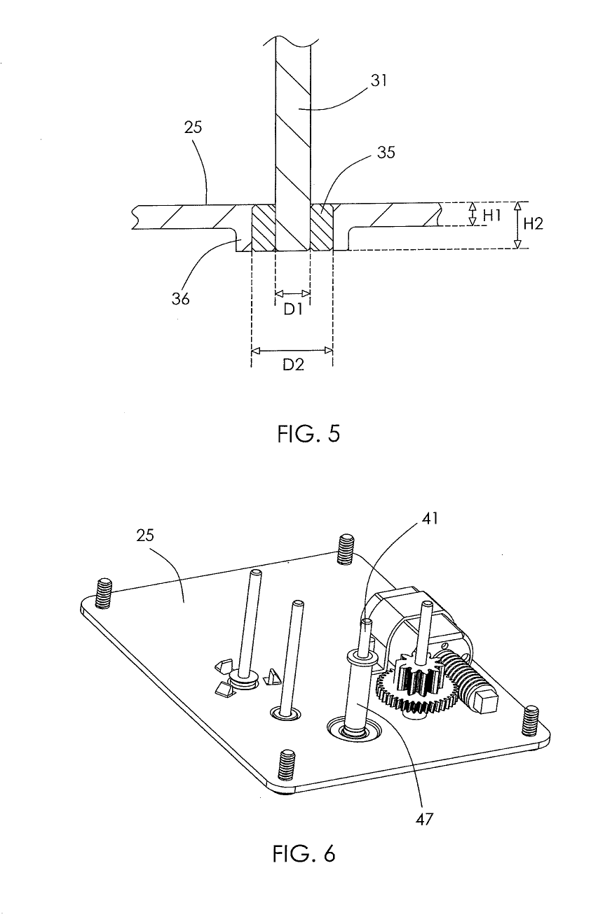

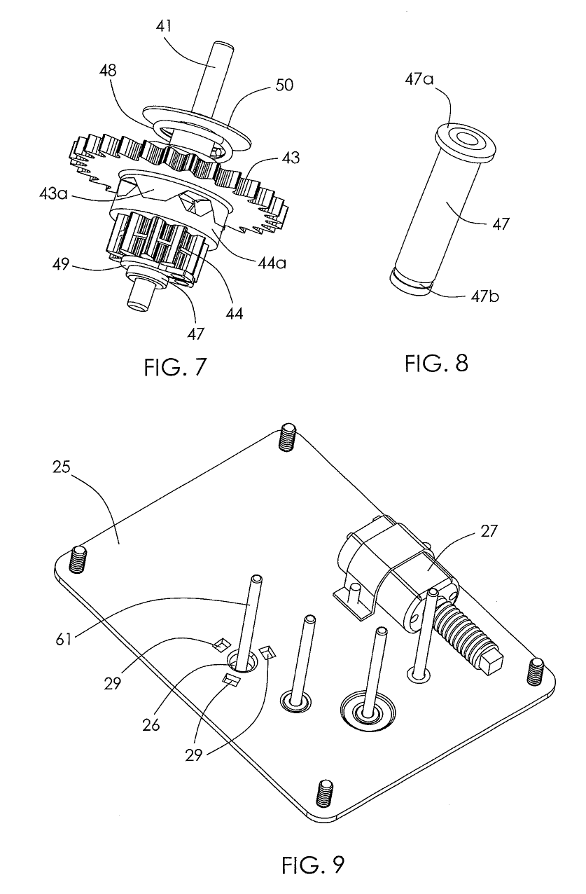

### DETAILED DESCRIPTION OF THE PREFERRED EMBODIMENTS

An actuator according to a first embodiment of the present invention is especially adapted for use in a game machine. For instance, the actuator may be used to drive a camera that captures signals and sends the signals to the game machine.

As shown in the figures, the actuator comprises a housing 21 having a cover 22 and a support plate 25. The housing accommodates a motor 27 and an output shaft 23 connected to the motor 27 via a step-down gear train. In use the output shaft 23 is arranged to drive an external driven member (not shown) such as a camera. The motor 27 is mounted on the support plate 25. Four fixed shafts 31, 41, 51 & 61 are fixed to the support plate and the cover 22 in a manner substantially perpendicular to the support plate 25. The cover 22 functions as a top plate to support the top ends of the fixed shafts. The fixed shafts support gears of the gear train with a gear of the first shaft 31 engaging a worm 28 fitted to or formed in the shaft of the motor 27, and a gear of the fourth fixed shaft 61 engaging a gear of the output shaft 23. A first dual gear 33 and 34 is rotatably mounted on the first fixed shaft 31. A second dual gear 43 and 44 is rotatably mounted on the second fixed shaft 41. A third dual gear 53 and 54 is rotatably mounted on the third fixed shaft 51. A fourth dual gear 63 and 64 is rotatably mounted on the fourth fixed shaft 61. The output shaft 23 is rotatably mounted to housing 21 in a manner substantially parallel to the support plate 25.

The full gear train is shown in FIG. 2. The worm 28 of the motor 27 drives the driven gear 33 of the first dual gear. The pinion 34 of the first dual gear coaxially rotates with the driven gear 33 and drives the driven gear 43 of the second dual gear. The pinion 44 of the second dual gear coaxially rotates with the driven gear 43 and drives the driven gear 53 of the third dual gear. The pinion 54 of the third dual gear coaxially rotates with the driven gear 53 and drives the driven gear 63 of the fourth dual gear. The pinion 64 of the fourth dual gear coaxially rotates with the driven gear 63 and drives the output shaft 23. In this embodiment, a gear 24 is fixed to the output shaft 23 in mesh with the pinion 64. Both the pinion 64 and the gear 24 are bevel gears, allowing the 90 degree change in orientation of the axis of rotation, i.e. from vertical to horizontal in the orientation shown in FIG. 2.

The support plate 25 comprises a first mounting hole for fixing the first fixed shaft 31, a second mounting hole for fixing the second fixed shaft 41 and a third mounting hole for fixing the third fixed shaft 51. A first spacer 35 is press fitted in the first mounting hole and the first fixed shaft 31 is press fitted in the first spacer 35. A second spacer 45 is press fitted in the second mounting hole and the second fixed shaft 41 is press fitted in the second spacer 45. A third spacer 55 is press fitted in the third mounting hole and the third fixed shaft 51 is press fitted in the third spacer 55. Preferably, the spacers 35, 45 and 55 are made of sintered metal. The cost is reduced since the traditional rivet holes and the riveting processes are avoided. The assembly process is also simplified.

As a preferred embodiment, the mounting holes are formed as drawn holes in the support plate whereby hollow axial bosses 36, 46 and 56 are formed at respective mounting holes. The bosses create a hole having a depth which is greater than the thickness of the metal sheet forming the support plate 25. Each spacer firmly fits in a respective mounting hole and its boss. The surface area of the interface between the spacer and the support plate is increased due to the boss, thus creating a stronger connection between the fixed shaft and the support plate.

The fixed shafts 31, 41, 51 and 61 are small diameter shafts. Preferably, the outer diameter D1 of the fixed shaft 31 is 1.0 to 2.0 mm. The outer diameter D2 of the first spacer 35 is 2.0 to 4.0 mm. The thickness H1 of the support plate 25 is 0.8 to 2.0 mm. The thickness H2 of the support plate 25 at the boss 36 is 1.5 to 2.5 mm.

A plastic bushing 47, as more clearly shown in FIG. 8 is rotatably mounted to the second fixed shaft 41. The driven gear 43 and pinion 44 of the second dual gear are rotatably mounted on the bushing 47. The bushing 47 is made of an engineering plastic such as POM (polyformaldehyde). The bushing 47 can be made by injection molding and the cost is low.

In this embodiment, the second dual gear acts as a clutch. The driven gear 43 and the pinion 44 are spaced along the bushing 47. Axial teeth 43a are integrally formed in the driven gear 43, and axial teeth 44a are integrally formed in the pinion 44 and arranged to engage with the axial teeth 43a. In a normal state, the driven gear 43 and the pinion 44 rotate together by the engagement of the axial teeth 43a and 44a. However, the teeth, by their shape, are adapted to cause an axial separation between the driven gear (43) and the pinion (44), against the urging of the spring, when torque between the driven gear and the pinion exceeds a predetermined value, whereby the teeth disengage and the driven gear can rotate with respect to the pinion. This prevents excessive loads on the gears which may otherwise lead to damage of the gear train such as stripped teeth.

A flange 47a is formed at one end of the bushing 47 to support a compression spring 48. A circumferential groove 47b is formed at the other end of the bushing 47 to support a circlip such as C ring 49. The pinion 44 is retained on the bushing 47 and supported by the C ring 49. The spring 48 bears on the flange 47a and the driven gear 43 to urge the driven gear 43 axially along the bushing towards the pinion 44 to keep the engagement of the axial teeth 43a and 44a. Preferably a spring seat on the form of a washer 50 is provided between the flange 47a and the spring 48 to protect the flange. Preferably, the flange 47a has a bevel surface so that the radial outer diameter of the flange 47a gradually increases along the direction towards the second dual gear, to reduce the contact area with the cover 22. Alternatively, the spring 48 is disposed between the C ring 49 and the pinion 44.

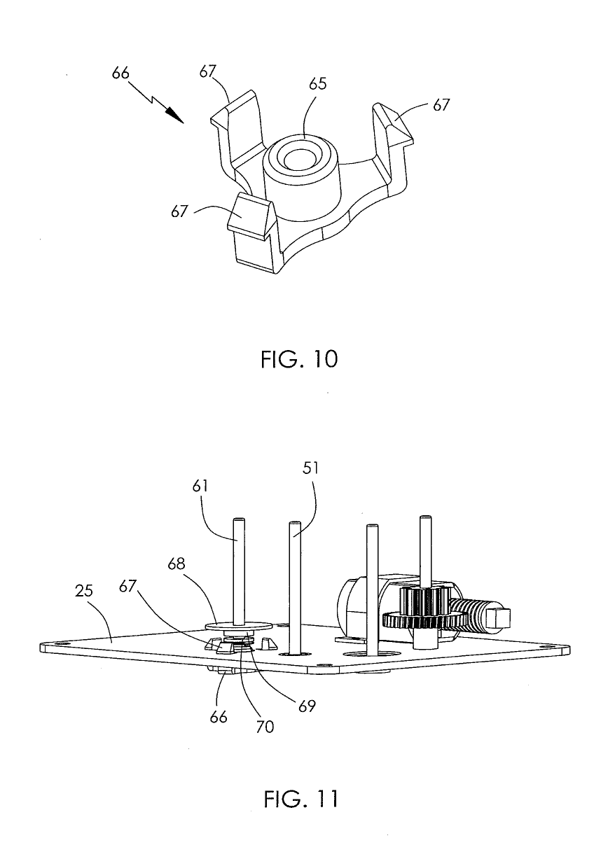

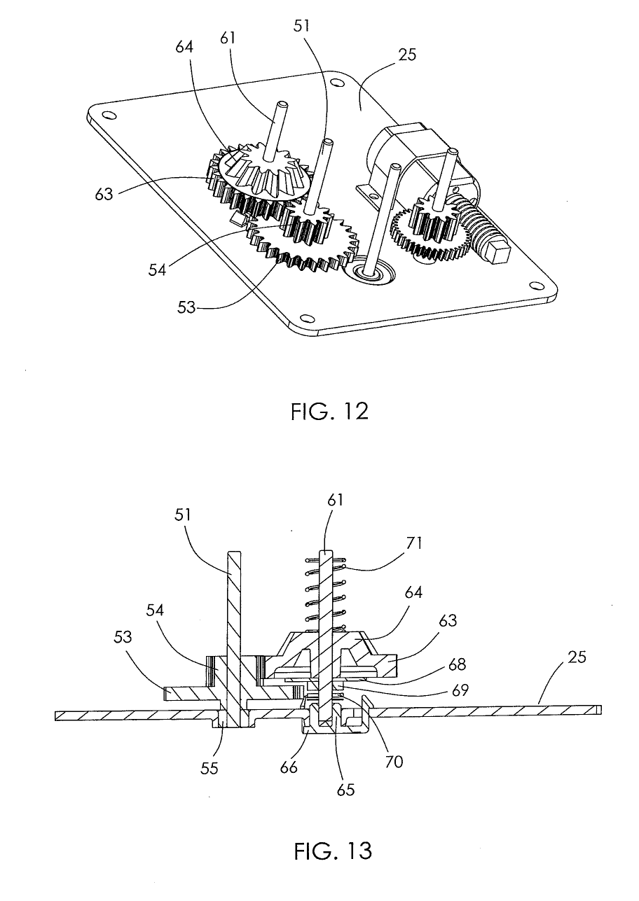

The support plate 25 has a shaft hole 26 through which the fourth fixed shaft 61 passes and three detent holes 29 disposed around the shaft hole 26, as shown in FIG. 9. A shaft seat 65, shown in FIG. 10, is disposed in the shaft hole 26 to support the fourth fixed shaft 61. A mounting plate 66 having three integral lugs 67 is integrally formed at one end of the shaft seat 65. Hooks are formed at the free ends of the lugs 67 to snap-fit and interlock with the respective detent holes 29. In this embodiment, the shaft seat 65 is press fitted in the shaft hole 26, and the fourth fixed shaft 61 is fitted in the shaft seat 65. The other end of the fourth fixed shaft 61 is fixed to the cover 22. The shaft seat 65 is made of plastic by injection molding. The cost is low since the traditional thread is avoided.

As noted above, the pinion 64 of the fourth dual gear is a bevel gear. The corresponding bevel gear 24 is fixed to the output member 23 to mate with the pinion 64. The driven gear 63 of the fourth dual gear is disposed between the pinion 64 and the support plate 25. At least two washers 68 and 69 are axially stacked between the support plate 25 and the driven gear 63 to adjust the distance between the support plate 25 and the driven gear 63 and control the play between the fourth dual gear and the bevel gear 24. Specifically, the first washer 68 is disposed between the fourth dual gear and the second washer 69. The outer diameter of the first washer 68 is smaller than the outer diameter of the driven gear 63 of the fourth dual gear to avoid the first washer 68 interfering with the pinion 54 of the third dual gear. The outer diameter of the second washer 69 is smaller than the outer diameter of the first washer 68 to avoid the second washer 69 interfering with the driven gear 53 of the third dual gear. The first and second washers, in effect, space the dual gears from the support plate by a desired distance, to correctly mate with the pinion 54 of the upstream fixed shaft 51.

Additional washers such as a third washer 70 may be used to further reduce the play. Preferably, the inner diameter of shaft hole 26 (FIG. 9) is larger than the outer diameter of the first washer 68 and the additional washer. During assembly, when the fixed shafts have been fixed to the support plate 25 or the cover 22 and the support plate 25 is mounted to the housing 21, one or more washers 68, 69, 70 are fitted onto the fourth fixed shaft 61 to further control the axial play, before the shaft seat 65 is snap fitted to the support plate 25. Further more, a compression spring 71 is disposed between the cover 22 and the pinion gear 64 to maintain a desired gap between the pinion 64 and the bevel gear 24 for efficient meshing of the bevel gears. Preferable, the washers 68, 69, 70 are made of stainless steel.

In this embodiment, the output shaft 23 is a rotatable shaft. However, a person of ordinary skill in the art should recognize that additional components could be attached to the output shaft to vary the output. For instance, an output member could be fixed perpendicularly to the output shaft 23 to cause a tilting movement of the driven member.

The actuator of the present invention also has a particular application for use in vending machines, automobile door lock systems, automobile mirror adjusters, etc.

In the description and claims of the present application, each of the verbs “comprise”, “include”, “contain” and “have”, and variations thereof, are used in an inclusive sense, to specify the presence of the stated item but not to exclude the presence of additional items.

Although the invention is described with reference to one or more preferred embodiments, it should be appreciated by those skilled in the art that various modifications are possible. Therefore, the scope of the invention is to be determined by reference to the claims that follow.

1. An actuator comprising a support plate, a motor mounted to the support plate and driving an output shaft via a gear train,
wherein the gear train comprises a number of dual gears rotatably mounted on respective fixed shafts mounted to the support plate and extending substantially perpendicular to the support plate.

2. The actuator of claim 1, wherein a spacer is fixed to a mounting hole formed in the support plate, the spacer having a hole defined therein and one of the fixed shafts being fixed to the spacer as a press fit in the hole of the spacer.

3. The actuator of claim 2, wherein the outer diameter of said fixed shaft is from 1.0 to 2.0 mm.

4. The actuator of claim 2, wherein the outer diameter of the spacer is from 2.0 to 4.0 mm.

5. The actuator of claim 3, wherein the thickness of the support plate is from 0.8 to 2.0 mm.

6. The actuator of claim 2, wherein a hollow axial boss is formed around the mounting hole, and the spacer is a press fit in the mounting hole and the boss.

7. The actuator of claim 6, wherein the thickness of the support plate, including the axial height of the boss is from 1.5 to 2.5 mm.

8. The actuator of claim 1, wherein the gear train further comprises a plastic bushing rotatably disposed on one of the fixed shafts, and one of the dual gears is rotatably mounted to the bushing.

9. The actuator of claim 8, wherein the dual gear mounted to the bushing comprises a driven gear and a pinion that is axially separable from the driven gear, both the driven gear and the pinion having axially extending teeth arranged to be mutually engaged to make the driven gear and the pinion rotate together, and a compression spring being mounted to the bushing to urge the teeth into engagement, the teeth being adapted to cause an axial separation between the driven gear and the pinion, against the urging of the spring, when torque between the driven gear and the pinion exceeds a predetermined value, whereby the driven gear can rotate with respect to the pinion.

10. The actuator of claim 9, wherein a flange is formed at one end of the bushing to support the spring or the dual gear.

11. The actuator of claim 1, further comprising a shaft seat disposed in a shaft hole defined in the support plate to support one of the fixed shafts, the shaft seat being fixed to the support plate by a snap-fit connection.

12. The actuator of claim 11, wherein at least two detent holes are formed in the support plate, and a mounting plate having integral lugs is integrally formed with the shaft seat, hooks being formed on the lugs to snap-fit and interlock with respective detent holes.

13. The actuator of claim 11, wherein at least one washer is mounted to the fixed shaft supported by the shaft seat through the shaft hole before the shaft seat is fixed to the support plate to adjust end play of the dual gear mounted to the fixed shaft.

14. The actuator of claim 1, wherein a first washer and a second washer are mounted to one of the fixed shafts and axially stacked between the support plate and the dual gear mounted on said fixed shaft to space the dual gear from the support plate by a desired distance.

15. The actuator of claim 14, wherein the first washer is disposed between the second washer and the dual gear, and the outer diameter of the first washer is larger than the outer diameter of the second washer.

16. The actuator of claim 14, wherein the first washer and the second washer are made of stainless steel.

17. The actuator of claim 15, wherein at least one third washer is disposed between the second washer and the support part to adjust the position of the dual gear with respect to the support plate.

18. A game machine incorporating the actuator of claim 1, wherein the output shaft drives a driven member of the game machine.

19. The game machine of claim 18, wherein the driven member is a camera that is electrically connected to the game machine.
